(19) United States
(12) Patent Application Publication
(10) Pub. No.: US 2012/0262032 A1
(43) Pub. Date: Oct. 18, 2012

(54) SHIELDING STRUCTURE

(76) Inventors: Chi-Lu Li, (US); Bo-Sheng Huang, (US); Shun-Hsing Hsiao, (US)

(21) Appl. No.: 13/087,299

(22) Filed: Apr. 14, 2011

(51) Int. Cl. H02K 11/00

(52) U.S. Cl. 310/68 B

(57) ABSTRACT

A shielding structure disposed between a rotary motor and a resolver for resolving angular position thereof. The shielding structure includes a first shielding body made of a material with a permeability more than 4000. The first shielding body is sandwiched between the resolver and the rotary motor for shielding the resolver from the rotary motor. The first shielding body provides a path of low magnetic resistance to change the direction of magnetic flux and lower the electromagnetic interference of the magnetic field with the operation of the resolver. Accordingly, the resolver can more stably output resolution signals at higher precision.

### BACKGROUND OF THE INVENTION

1. Field of the Invention

The present invention relates generally to a resolver, and more particularly to a shielding structure for reducing electromagnetic interference of the magnetic field with the operation of the resolver.

2. Description of the Related Art

A conventional resolver is used to analyze angular position of a rotary motor and provide corresponding positional data for controlling the rotary motor. In space structure, the resolver is generally mounted at one end of the rotary shaft of the rotary motor with a rotor of the resolver synchronously rotated with the motor. The resolver serves to sense magnetic field change and output corresponding amplitude modulation signals. After resolved, the corresponding angular positional data of the motor can be obtained. The operation principle and techniques of the resolver pertain to prior art and thus will not be further described hereinafter.

The motor and the resolver are both powered by electricity. Through magnetic field change, the electrical energy is converted into mechanical energy as driving power. At the same time, the resolver senses the magnetic field change to generate corresponding amplitude modulation signals. The resolver is serially connected to the rotary motor to synchronously resolve the angular position of the motor. However, the precision of the resolution is subject to electromagnetic interference. The electromagnetic interference caused by voltage produced due to flux linkage of the conductor passing through the magnetic field is quite obvious, especially with respect to a resolver requiring higher resolution precision.

### SUMMARY OF THE INVENTION

It is therefore a primary object of the present invention to provide a shielding structure, which is able to shield a resolver from external magnetic field and lower electromagnetic interference of the magnetic field with the operation of the resolver. Accordingly, the resolver can more stably output signals at higher precision.

To achieve the above and other objects, the shielding structure of the present invention is disposed between a rotary motor and a resolver serially connected with the rotary motor. The shielding structure includes a shielding body made of a material with a permeability more than 4000. The shielding body is sandwiched between the resolver and the rotary motor for shielding the resolver from the rotary motor. The shielding body provides a path of low magnetic resistance to change the direction of magnetic flux and lower the electromagnetic interference of the magnetic field with the operation of the resolver. Accordingly, it is ensured that the resolver can stably output resolution signals.

The present invention can be best understood through the following description and accompanying drawings, wherein:

### BRIEF DESCRIPTION OF THE DRAWINGS

FIG. 1 is a perspective view of a preferred embodiment of the present invention;

FIG. 2 is a sectional view taken along line 2-2 of FIG. 1; and

FIG. 3 is a sectional view taken along line 3-3 of FIG. 1.

### DETAILED DESCRIPTION OF THE PREFERRED EMBODIMENTS

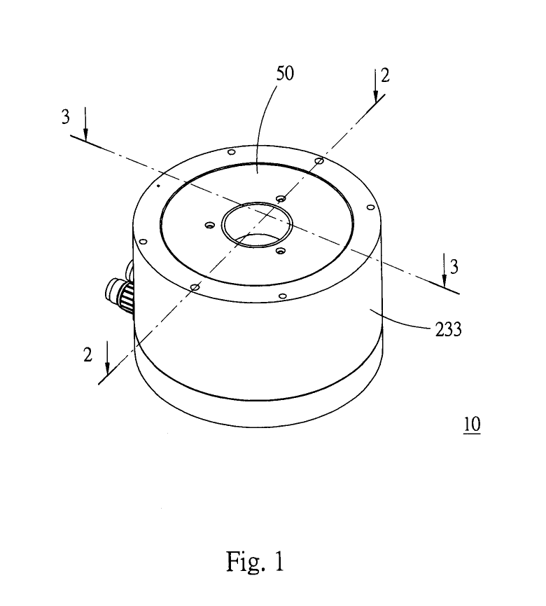

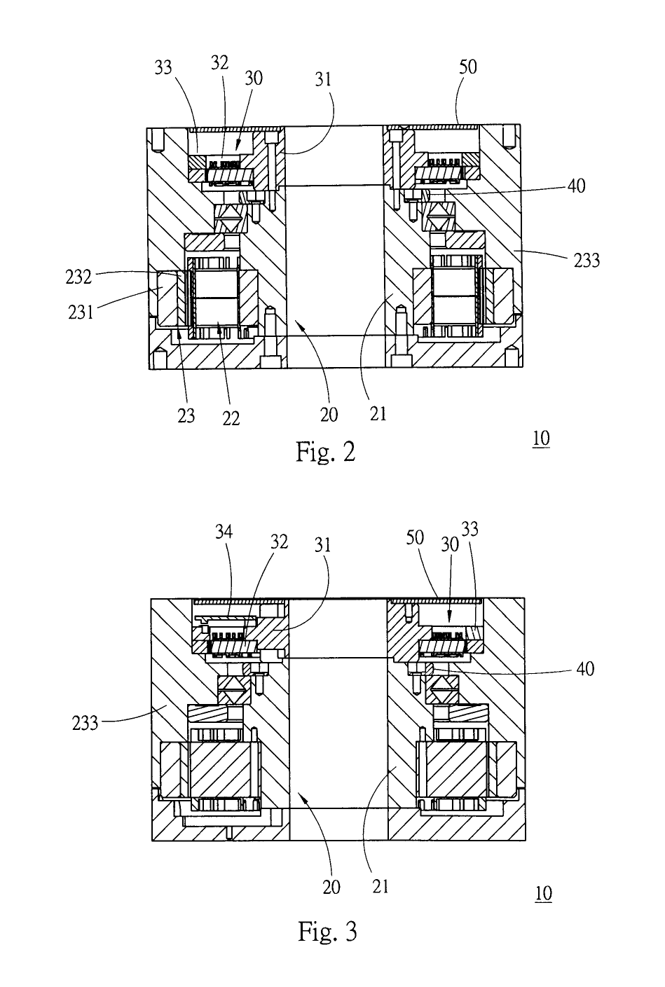

Please refer to FIGS. 1, 2 and 3. According to a preferred embodiment, the shielding structure 10 of the present invention includes a rotary motor 20, a resolver 30, a first shielding body 40 and a second shielding body 50.

In this embodiment, the motor 20 is a conventional outer rotor motor. Substantially, the motor 20 includes a stationary central shaft 21, a stator assembly 22 annularly arranged around the central shaft 21 and a rotor assembly 23 coaxially positioned around the stator assembly 22. Through the magnetic field change between the stator assembly 22 and the rotor assembly 23, the electrical energy is converted into mechanical energy for driving the rotor assembly 23 to rotate around the curvature center of the central shaft 21.

To speak more specifically, the rotor assembly 23 includes an annular rotor seat 231. Multiple magnets 232 are attached to inner circumference of the rotor seat 231 opposite to outer circumference of the stator assembly 22. A rotor case 233 is coaxially fixedly connected with an axial end of the rotor seat 231 and synchronously rotatable with the rotor seat 231.

In this embodiment, the resolver 30 includes at least one Hall sensor for position feedback. Substantially, the resolver 30 includes an annular inner retainer seat 31. An axial end of the inner retainer seat 31 is fixedly connected with an axial end of the central shaft 21. An annular stator member 32 is coaxially fixedly connected on the inner retainer seat 31. An annular rotor member 33 is coaxially positioned around outer circumference of the stator member 32 and fixedly connected with the rotor case 233, whereby the rotor member 33 can be driven to synchronously rotate with the rotor assembly 23. At least one Hall sensor 34 is fixedly disposed on the inner retainer seat 31 for sensing the magnetic field change that takes place in rotation of the rotor member 33 between the inner circumference of the rotor member 33 and the outer circumference of the stator member 32.

The first shielding body 40 is an annular plate body made of a material with a permeability more than 4000, such as silicon steel sheet and mu-metal. The first shielding body 40 is disposed between the rotary motor 20 and the resolver 30 to provide a magnetic field shielding effect. To speak more specifically, the first shielding body 40 is coaxial with the central shaft 21 and fixedly sandwiched between a shoulder section 211 of an axial end of the central shaft 21 and the inner retainer seat 31 to provide a magnetic field shielding effect between the motor 20 and the resolver 30.

The second shielding body 50 is also an annular plate body made of a material with a permeability more than 4000, such as silicon steel sheet and mu-metal. The second shielding body 40 is coaxial with the central shaft 21 and fixedly disposed on the end face of the other axial end of the inner retainer seat 31 to shield the resolver 30 from the exterior and avoid electromagnetic interference of the exterior with the operation of the resolver 30.

According to the above arrangement, the high-permeability material with a permeability more than 4000 provides a path of low magnetic resistance to change the direction of magnetic flux and reduce the magnetic field intensity of the shielded area. Accordingly, the first shielding body 40 serves to lower the affection of the magnetic field of the motor 20 on the resolver, whereby the resolver 30 can output more stable signals. On the other hand, the second shielding body 50 serves to shield the resolver 30 from the outer side and avoid electromagnetic interference of the external magnetic field with the operation of the resolver 30, whereby the resolver 30 can more truly output signals. The configuration of the second shielding body 50 is not limited to that of the annular plate body. The second shielding body 50 can be otherwise shaped to achieve better shielding effect.

The above embodiments are only used to illustrate the present invention, not intended to limit the scope thereof. Many modifications of the above embodiments can be made without departing from the spirit of the present invention.

What is claimed is:

1. A shielding structure comprising:
a rotary motor;
a resolver, an end face of the resolver being positioned in adjacency to and in alignment with an end face of an axial end of the rotary motor; and
a first shielding body, which is a plate body made of a material with a permeability more than 4000, the first shielding body being disposed between the adjacent end faces of the resolver and the rotary motor.

2. The shielding structure as claimed in claim 1, wherein the first shielding body is an annular plate body.

3. The shielding structure as claimed in claim 1, wherein the first shielding body is made of mu-metal.

4. The shielding structure as claimed in claim 1, further comprising a second shielding body, the second shielding body being a plate body made of a material with a permeability more than 4000, the second shielding body being attached to the other end face of the resolver.

5. The shielding structure as claimed in claim 4, wherein the second shielding body is an annular plate body.

6. The shielding structure as claimed in claim 4, wherein the second shielding body is made of mu-metal.
